(19) United States
(12) Patent Application Publication
(10) Pub. No.: US 2006/0163943 A1
(43) Pub. Date: Jul. 27, 2006

(54) Method and device for automatically initiating an emergency brake procedure in motor vehicles

(76) Inventors: Volker Von Holt, Braunschweig (DE); Ingo Meinke, Wolfsburg (DE); Markus Maurer, Bohmfeld (DE); Fred Oechsle, Ludwigsburg (DE); Joachim Thiele, Beilstein (DE); Ulrike Ahlrichs, Korntal-Muenchingen (DE); Martin Heinebrodt, Stuttgart (DE); Bernhard Lucas, Besigheim (DE)

Correspondence Address: KENYON & KENYON LLP, ONE BROADWAY, NEW YORK, NY, 10004, US

(21) Appl. No.: 10/524,700

(22) PCT Filed: Aug. 1, 2003
(86) PCT No.: PCT/DE03/02588

§ 371 Date: Feb. 7, 2006

(30) Foreign Application Priority Data
Aug. 17, 2002 (DE) 102 37 714.6

(51) Int. Cl. B60T 8/74; B60T 15/14; G06F 17/10

(52) U.S. Cl. 303/177; 303/20; 701/301

(57) ABSTRACT

A method for automatically initiating an emergency braking sequence including preliminary warning braking in motor vehicles, wherein the achievable vehicle deceleration is determined during warning braking and the time of initiating emergency braking is varied as a function of the determined vehicle deceleration.

### FIELD OF THE INVENTION

The present invention relates to a method for automatically initiating an emergency braking sequence including preliminary warning braking in motor vehicles and a control device for carrying out this method.

### BACKGROUND INFORMATION

Motor vehicles are being increasingly equipped with driving assistance systems which support the driver in driving the vehicle and make it easier for him to perform certain driving maneuvers. One example of a known driver assistance system is a radar-supported adaptive cruise control system (ACC), in which the distance and the relative velocity of a vehicle traveling ahead are measured using a radar sensor mounted on the front of the vehicle, and if the distance drops below a certain safety distance, which is also dependent on the vehicle's own velocity, a warning is issued to the driver, or the distance to the vehicle ahead is automatically regulated via intervention in the propulsion and/or braking system of the vehicle.

German Published Patent Application No. 43 10 354 describes an adaptive cruise control system of this type, in which, when the vehicle approaches another vehicle traveling ahead and the distance drops below a certain warning distance, initially a relatively gentle warning braking is performed to prepare the driver and the passengers, as well as any traffic behind the vehicle, for an imminent braking maneuver, and in which, if the distance to the vehicle ahead further decreases, automatic intervention in the braking system takes place with the objective of regulating the distance to the setpoint distance. According to this approach, warning braking is also to be used for gaining more information about the coefficient of friction of the roadway, which is a function of the roadway characteristics, the condition of the tires, and the weather conditions and in turn affects the brakability and thus the stopping distance of the vehicle. The information gained during warning braking about the coefficient of friction is used for changing the setpoint value of the adaptive cruise control. If, during warning braking, it turns out that the roadway has a relatively low coefficient of friction, a longer setpoint distance is selected to increase driving safety.

The present invention, in contrast, is concerned with another aspect of a driver assistance system, namely with an automatic emergency brake. In this case, an automatic emergency braking sequence is to be initiated in the event of obstacles appearing relatively suddenly if the driver himself does not notice the obstacle in a timely manner or does not respond quickly enough. In these cases the acute risk of collision is to be avoided by emergency braking being automatically initiated, or, if the collision is unavoidable, at least the damage, in particular personal injury, should be limited.

The function of the automatic emergency brake also depends on automatic obstacle recognition with the help of a radar sensor or a comparable sensor system. On the basis of automatic obstacle recognition and an objective evaluation of the situation, the system must then decide whether and when emergency braking is to be initiated. Also in this case, a warning braking, which has the main objective of calling the driver's attention to the danger situation and prompting him to actively intervene in the process, precedes the actual emergency braking.

It is generally assumed here that vehicles which are equipped with such an automatic emergency brake also have an antilock system (ABS) and/or an electronic stability program (ESP) for stabilizing the vehicle dynamics. These systems ensure that the vehicle still remains maneuverable even in the event of full braking. Accordingly, the preferred collision avoidance strategy is usually not to brake the vehicle to a standstill as quickly as possible while keeping the steering fixed, but rather to perform an evasive maneuver via intervention in the steering during ongoing braking in order to possibly drive around the obstacle.

In many cases, for example, when the obstacle is formed by a slow vehicle, which suddenly cuts in from the adjacent right-hand lane, the driver will attempt to get out of the danger situation also in some other way, for example, by warning the driver of the vehicle cutting in by operating the horn or a headlamp flasher or, in the case of a three-lane road, checking the traffic behind to see whether escaping to the adjacent left-hand lane is possible. The driver thus suddenly faces the need to perform a plurality of activities virtually at the same time. In this case the driver is easily overwhelmed with the result that he initiates the necessary emergency braking by a critical fraction of a second too late. Against this background, the automatic emergency braking function represents a useful supporting measure for enhancing driving safety.

However, a decisive factor in the success and acceptance of the automatic emergency brake is that the emergency braking function is initiated in a timely manner, but also not too early and not unnecessarily. Initiating emergency braking prematurely or unnecessarily represents not only significant impairment of the driving comfort, but may also result in irritation to the traffic behind and thus may itself become a cause for accidents.

### SUMMARY OF THE INVENTION

An object of the present invention is therefore to provide a method and a control device which make it possible to optimize the time for initiating emergency braking.

This object is achieved by determining the achievable vehicle deceleration during warning braking and by varying the time of initiating emergency braking as a function of the determined vehicle deceleration.

The proposed method is thus somewhat similar to the measures used in the aforementioned adaptive cruise control; however, these measures are taken here in a different context and serve a different objective. The objective in the present invention is to modify the delay between warning braking and the deployment of the actual emergency braking as a function of the determined ability of the vehicle to decelerate. The present invention is based on the principle that normally a certain waiting time, typically on the order of one second or somewhat less, should elapse between warning braking and the initiation of actual emergency braking, which gives the driver the opportunity to become aware of the emergency situation and prepare himself for an evasive maneuver that may become necessary. However, if it turns out during warning braking that the vehicle's ability to decelerate is strongly reduced due to the current condition of the roadway, the normally reasonable waiting time may be significantly reduced, in the extreme case even to zero, so that in this special case emergency braking may be initiated earlier.

Since warning braking immediately precedes emergency braking, the ability of the vehicle to decelerate, determined during warning braking, almost certainly represents the current condition of the roadway, so that the time for initiating emergency braking may be selected accordingly. Likewise, a certain flexibility is gained due to the variable interval between warning braking and emergency braking, which allows a relatively late point in time to be established for initiating warning braking and thus to diminish the frequency of unnecessary erroneous warnings, which would negatively affect the acceptance of the system as a whole.

Advantageous embodiments of the present invention are derived from the subclaims. The coefficient of friction between tires and roadway surface, which is also needed and determined within an ESP system, may be considered in particular as a suitable measure for the vehicle deceleration that may be achieved and that is determined during warning braking. The vehicle deceleration which may be achieved may, however, also be influenced by other variables, in particular by the load, which in some modern vehicle types such as vans may amount to a considerable proportion of the total weight and thus have a sizeable influence on the braking response. The influence of this load may also be determined during warning braking and then taken into account as appropriate.

Since the coefficient of friction and possibly the load are also needed for the ESP function during the actual emergency braking, the present invention also offers the advantageous option of storing these variables, determined during warning braking, in the ESP system, so that they are available there in the event of emergency braking from the beginning and make it possible to initiate braking in a more controlled, in particular a faster, manner.

In order to determine, as accurately as possible, the vehicle's ability to decelerate, it is expedient to increase the braking pressure during warning braking to the point that at least one of the wheels is briefly locked, which results in maximum slip. The coefficient of friction may then be accurately determined for the locked wheel using known methods, for example, using the braking force at which the wheel locks up, or optionally using the angular acceleration with which the wheel re-accelerates after the brake is released. This angular acceleration is given by the torque, which is a function of the coefficient of friction, divided by the known moment of inertia of the wheel.

Since maximum vehicle deceleration is not yet desired in warning braking, it is possible to brake only the wheels of a single axle of the vehicle, preferably those of the driven axle, in warning braking. By comparing the wheel velocities of the braked wheels with the freewheeling (non-slipping) wheels, the slip of the braked wheels may then be accurately determined.

In the case of highly skid-resistant roadways, i.e., having a high coefficient of friction, it may not be possible or advisable to brake the braked wheels actually to the slip limit in some circumstances as part of warning braking. It is therefore advisable not to increase the braking force during warning braking beyond a certain maximum value. When the maximum value is attained without any perceptible slip occurring at the braked wheels, this indicates a high coefficient of friction of the roadway, in which case the time for the actual emergency braking is determined based not on the measured coefficient of friction, but on a suitably high estimated value of the coefficient of friction.

### BRIEF DESCRIPTION OF THE DRAWINGS

FIG. 1 shows a block diagram of a control device for carrying out the method.

FIGS. 2 (A) and (B) show the variation of braking force and wheel slip over time for an emergency braking sequence on skid-resistant roadway.

FIGS. 3 (A) and (B) show time diagrams similar to FIGS. 2(A) and (B) for an emergency braking sequence on a slippery roadway.

### DETAILED DESCRIPTION

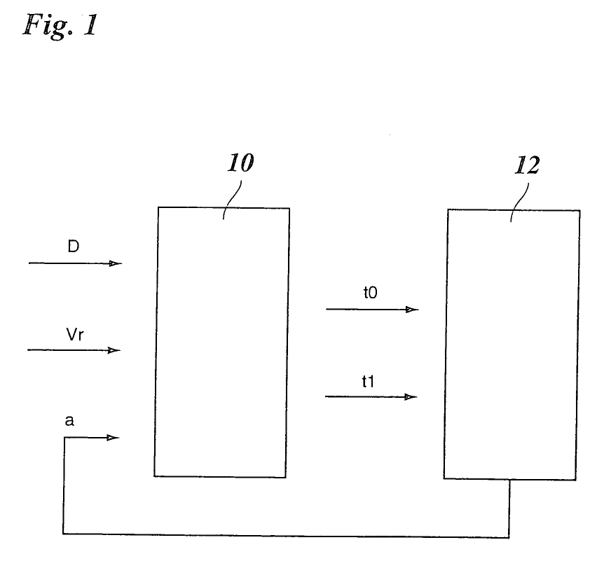

FIG. 1 shows a block diagram of a control device for an automatic emergency brake in a motor vehicle. The control device includes a situation analyzer unit 10 and an ABS/ESP control unit 12. Situation analyzer unit 10 may be part of an ACC (automatic cruise control) system, for example, and receives signals from a radar system (not shown), which locates objects situated in front of the vehicle. ABS/ESP control unit 12 is used in general for controlling braking sequences, including those initiated by the driver or by the ACC system, and for stabilizing the vehicle dynamics, and has in particular the function of controlling or regulating the braking pressure at all braked wheels of the vehicle in such a way that adequate adhesion of the tires to the roadway is ensured.

Data received by situation analyzer unit 10 for each object located by the radar sensor includes measured distance D of the object, relative velocity Vr of the object determined based on the Doppler shift, and angular data (not shown), on the basis of which a decision may be made on whether the located object is on the same lane and thus represents a relevant obstacle. For the sake of simplicity, it was assumed in FIG. 1 that only a single relevant object is present. Situation analyzer unit 10 decides, on the basis of the distance and relative velocity data, whether there is a risk of collision. For this purpose, situation analyzer unit 10 calculates whether it is possible to reduce measured relative velocity Vr within distance D to zero using full braking of the vehicle, or what residual relative velocity (impact velocity) remains if distance D has been reduced to zero. To calculate the deceleration of the vehicle when full braking is used, a realistic value should be used as a basis, which is a function of a plausible estimate of the roadway's coefficient of friction and of the vehicle's service weight if no previous information is available. Previous information is usually available for the service weight of the vehicle, since it is possible to estimate this service weight more or less accurately within the ACC regulation on the basis of the vehicle's acceleration response and the propulsion torque available in the engine management system. Previous information may be available on the roadway's coefficient of friction, in particular when driving on a slippery ice- or snow-covered roadway, because in this case the ESP system often becomes active within a traction control system, and the roadway's coefficient of friction is also determined and analyzed within this control. In the general case, where such previous information is not available, the coefficient of friction is determined assuming a dry roadway with normal skid-resistant properties. Refinements are possible, for example, in the form that a wet roadway is assumed when the windshield wiper is continuously on.

The collision risk is then estimated on the basis of the vehicle's ability to decelerate thus estimated, and a point in time t0 is determined at which initially warning braking is to be initiated due to acute collision risk. Furthermore, a preliminary value t1 for the actual emergency braking is determined, which follows warning braking with a certain time delay of 0.8 s, for example. The dynamics of the obstacle may also enter into the estimation of the collision risk and thus into the determination of points in time t0 and t1, for example, by taking into account the time derivative of measured relative velocity Vr. For example, if the obstacle is a vehicle traveling ahead, which initiates full braking on its part while the subject vehicle's own velocity remains essentially unchanged, the absolute value of (negative) relative velocity Vr will rapidly increase and it may be estimated when the vehicle ahead will become fully braked to a standstill.

Frequent erroneous warnings are to be avoided; therefore, it is usually impossible in practice to pursue a strict collision avoidance strategy in estimating points in time t0 and t1. Instead, points in time t0 and t1 are determined so that even if emergency braking is initiated at time t1, impact occurs unless the driver executes an evasive maneuver or the situation is eliminated in some other way. However, points in time t0 and t1 are selected so that the impact velocity is reduced at least to the point where under normal circumstances it does not result in injury to the occupants of the vehicle. In this case, also vehicle-specific data on the crash response of the vehicle enter into the determination of the permissible impact velocity, as well as the presence or absence of passive safety systems such as an airbag or the like.

When points in time t0 and t1 have been determined in this way, at time t0 ABS/ESP control unit 12 receives the command to initiate warning braking. During this warning braking the braking force is continuously increased and the ESP system checks whether slip is occurring at the braked wheels. For example, warning braking is carried out on the rear wheels only, so that the velocity of the front wheels may be used as a reference for computing slip S. The slip may then be computed, for example, as S=(Vu−Vb)/Vu, where Vu is the wheel velocity of the unbraked wheels and Vb is the wheel velocity of the braked wheels. Therefore, when the braked wheels lock up (Vb=0), then S=1. The roadway's coefficient of friction, i.e., the ability of the vehicle to decelerate, expressed, for example, by a negative acceleration value a, may then be determined on the basis of measured slip S and known braking force F. This ability to decelerate a is reported back to situation analyzer unit 10 and is used there to correct time t1, which was initially computed on a preliminary basis only, in order to take into account the roadway's coefficient of friction which is now more accurately known. For a low coefficient of friction and thus reduced ability to decelerate, time t1 is brought forward, so that the actual emergency braking is initiated earlier.

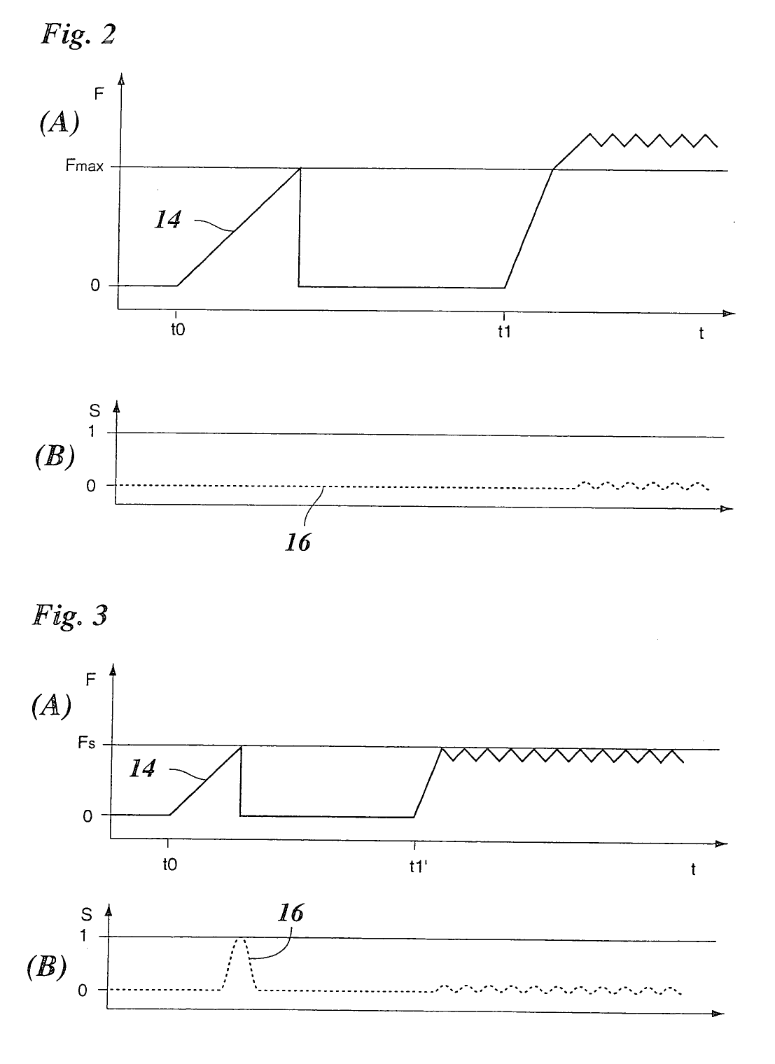

These sequences are illustrated in FIGS. 2 and 3 using two examples.

In FIG. 2(A), time t is plotted on the horizontal axis and braking force F acting on the braked wheels is plotted on the vertical axis. Curve 14 shows the variation of the braking force over time. Warning braking is initiated at time t0, computed by situation analyzer unit 10. During this warning braking, braking force F is continuously increased at a determined rate of increase, and any slip at the braked wheels is measured. Dashed curve 16 in FIG. 2(B) shows the measured slip. In the example shown, it turns out that no slip occurs during warning braking. This means that the roadway has a relatively high coefficient of friction (as estimated initially). Therefore the provisionally assumed value t1 for the time of initiating emergency braking does not have to be modified. Warning braking is discontinued as soon as the exerted braking force F (or the braking torque or a comparable parameter) attains a defined maximum value Fmax.

The actual emergency braking is then initiated at time t1. Since now it is known that the roadway has relatively good skid-resistant properties and no slip will occur for braking forces below Fmax, the braking force may be increased at a higher rate at least up to point Fmax, so that braking is initiated earlier as appropriate. If the braking force is increased further beyond Fmax, it may be advisable to somewhat reduce the rate of increase, so that wheel slip is detected in a timely manner and the system is prevented from overshooting. As soon as wheel slip occurs (curve 16), the braking force is modulated as known within an ABS regulation and the vehicle is safely braked to a standstill.

FIG. 3 illustrates the same procedure on a slippery roadway. Warning braking is initiated at calculated time t0. However, due to the lower coefficient of friction of the roadway, wheel slip occurs already at a lower braking force Fs, as curve 16 in FIG. 3(B) shows. Warning braking is continued using increasing braking force until slip S reaches a defined limiting value (≦1), e.g., until the braked wheel locks up. Only then is warning braking discontinued. In this way, the roadway's coefficient of friction is accurately determined on the basis of the dynamic response of the braked wheel, and the resulting vehicle's ability to decelerate a is reported back to situation analyzer unit 10. Thereupon, this unit corrects time t1 for initiating emergency braking. FIG. 3(A) shows that emergency braking now begins at an earlier point in time t1′. The lower the measured coefficient of friction of the roadway, the farther time t1′ is brought forward; in the extreme case, for a very slippery roadway, it may be brought forward to the point that emergency braking follows warning braking without interruption.

As long as a certain delay remains between warning braking t0 and emergency braking t1′, braking force F is increased at time t1′ at a high rate to value Fs also in this case. Since this value is already known, braking pressure overshooting may be avoided despite the rapid buildup of braking pressure. The braking pressure is subsequently modulated again in the customary manner.

The overall braking time available is thus lengthened due to time t1′ for initiating emergency braking having been brought forward, so that the initial erroneous estimate of the ability to decelerate a may be at least partly compensated for. Furthermore, early knowledge of the slip limit makes it possible to optimize initiation of emergency braking.

1-6. (canceled)

7. A method for automatically initiating an emergency braking sequence, comprising:
performing a preliminary warning braking in a motor vehicle;
determining an achievable vehicle deceleration during the preliminary warning braking; and
varying a time of initiating an emergency braking as a function of the determined achievable vehicle deceleration.

8. The method as recited in claim 7, further comprising:
decelerating at least one wheel of the motor vehicle to a slip limit during the preliminary warning braking.

9. The method as recited in claim 7, further comprising:
increasing a braking force during the preliminary warning braking until one of at least one wheel reaches a slip limit and one of the braking force and a correlated state variable attains a defined maximum value; and
when a maximum value is attained without a wheel having reached the slip limit, using a high estimated value of the attainable vehicle deceleration as a basis.

10. The method as recited in claim 7, wherein:
the attainable vehicle deceleration is represented by a parameter that indicates a coefficient of friction between a roadway and tires.

11. The method as recited in claim 10, further comprising:
determining the coefficient of friction during preliminary warning braking; and
controlling, in accordance with the determined coefficient of friction, a braking pressure buildup when initiating the emergency braking.

12. A control unit, comprising:
a situation analyzer unit for determining a point in time for initiating a warning braking and a later, provisional point in time of initiating an emergency braking on the basis of a measured distance to an obstacle and a measured relative velocity of this obstacle, as well as on the basis of a provisional value of a vehicle deceleration; and
an ABS/ESP control unit for modulating a braking pressure as a function of a slip condition of a braked wheel while computing a coefficient of friction of a roadway, the coefficient of friction being determined during the warning braking, the ABS/ESP control unit reporting the determined coefficient of friction to the situation analyzer unit, wherein:
the situation analyzer unit corrects the provisional point in time of initiating an emergency braking on the basis of the vehicle deceleration as given by the determined coefficient of friction.
